(19) United States
(12) Patent Application Publication
(10) Pub. No.: US 2010/0138564 A1
(43) Pub. Date: Jun. 3, 2010

(54) VIRTUAL PORT NUMBER ASSIGNING METHOD AND A COMPUTER READABLE MEDIUM THAT STORES A VIRTUAL PORT NUMBER ASSIGNING PROGRAM

(75) Inventors: CHING-HSIANG LEE, Taipei (TW); TSU-YI KU, Taipei (TW)

Correspondence Address: KILE GOEKJIAN REED & MCMANUS, 1200 NEW HAMPSHIRE AVE, NW, SUITE 570, WASHINGTON, DC, 20036, US

(73) Assignee: AZUREWAVE TECHNOLOGIES, INC.

(21) Appl. No.: 12/429,504

(22) Filed: Apr. 24, 2009

(30) Foreign Application Priority Data
Nov. 28, 2008 (TW) 97146401

(51) Int. Cl. G06F 3/00

(52) U.S. Cl. 710/8

(57) ABSTRACT

A virtual USB port numbers assigning method, applicable to a client device for generating a virtual port representing an actual port of a remote USB hub. The steps comprise: detecting an electrical device connecting to the actual port; requesting data regarding the actual port and the connected electronic device, such as the MAC address and actual port number of the remote USB hub, and the PID and VID of the electrical device; evaluating the data; and assigning virtual ports according to the evaluation result. By assigning fixed virtual port number to each electrical device, so as to prevent the operating system from repeatedly asking users to install the driver program of the electrical device.

### BACKGROUND OF THE INVENTION

1. Field of the Invention

The present invention relates to a virtual port number assigning method; in particular, to a virtual port number assigning method at the local client end for an electronic device connected to a remote USB hub.

2. Description of Related Art

There are currently many types of electronic devices, such as printers, web cams, digital televisions, etc. As the number of the electronic devices increases, the number of associated necessary cables for connection also increases accordingly. The large number of connection cables may make a user feel inconvenient. Therefore, hubs for electronic devices have been developed so that a user may connect multiple electronic devices to a hub, and local client devices such as a notebook computer may utilize wired or wireless transmission to remotely share and utilize these electronic devices connected to the hub. Thereby the issue of complicated wiring may be improved.

Due to differences in required functions, wireless transmission technology spans over many platforms and formats, for example the worldwide interoperability for microwave access (WiMAX) is for long range wide area transmission, such as in a metropolitan area network (MAN); wireless fidelity (Wi-Fi) is for intermediate range transmission, such as in a local area network (LAN); Bluetooth is for short range transmission, such as a small personal area network (PAN) between two electronic devices; and ZigBee is for low speed, low consumption wireless network, etc.

As more electronic devices are invented, the usage of connection cables also increase accordingly, and the utilization of a wired or wireless remote device sharing hub (i.e. remote USB hub) may be a great way to reduce connection cables. Generally speaking, system operation platform such as Windows or Linux, for the consideration of peripheral device management settings, tends to assign port numbers according the USB port that the peripheral device is connected with. However, when utilizing a remote USB hub that remotely connects peripheral device to the local client device for usage, the local client device may repeatedly request user settings or driver programs, due to the fact that the remotely connected peripheral device is not always assigned with a constant port number, thereby resulting in unnecessary wastage of storage space and user inconvenience. Therefore a method is needed to prevent a remotely shared peripheral device to cause repeated download of driver programs and user settings to a local client device (i.e. notebook computer).

### SUMMARY OF THE INVENTION

The object of the present invention is to provide a virtual port number assigning method, which generates a virtual port for simulating a permanent port at the client device when a peripheral electronic device is connected to a remote USB hub, and the port number of the virtual port is transmitted to a system operation platform of the client device. Thereby, the peripheral electronic device has a permanent port number representation in the system operation platform, so that the issue of a system operation platform repeatedly requesting driver program and user settings of the same peripheral electronic device may be solved.

In order to achieve the aforementioned objects, according to an embodiment of the present invention, a virtual port number assigning method is provided, applicable to a client device, for generating a virtual port at the client device to represent an actual port of a remote USB hub, the steps includes: detecting an electronic device being connected to the actual port of the remote USB hub; requesting data regarding the actual port and the connected electronic device, wherein the data includes the media access control (MAC) address of the remote USB hub, the port number of the actual port of the remote USB hub, the product identification (PID) of the electronic device, and the vendor identification (VID) of the electronic device; comparing the data, so as to determine whether or not a virtual port representing the actual port of the remote USB hub already exists; and assigning the virtual port according to the comparison result. Therein regarding the assigning of the virtual port, if the comparison result is yes, then the virtual port is assigned as the permanent port of the client device representing the actual port of the remote USB hub which the electronic device is connected to, and the port number of the virtual port is transmitted to a system operation platform of the client device, as if the electronic device was directly connected to the client device via the virtual port; if the comparison result is no, then a virtual USB hub is generated at the client device to represent the remote USB hub, the virtual USB hub including a new virtual port for representing the actual port of the remote USB hub, so that the new virtual port is assigned as the permanent port of the client device representing the actual port of the remote USB hub which the electronic device is connected to, and the port number of the new virtual port is transmitted to a system operation platform of the client device, as if the electronic device was directly connected to the client device via the new virtual port.

According to another embodiment of the present invention, a virtual port number assigning method is provided, applicable to a client device, for generating a virtual port at the client device to represent an actual port of a remote USB hub, the steps includes: detecting an electronic device being connected to the actual port of the remote USB hub; requesting data regarding the actual port and the connected electronic device, wherein the data includes the MAC)address of the remote USB hub, the port number of the actual port of the remote USB hub, the PID of the electronic device, and the VID of the electronic device; comparing the data against all the previously generated virtual ports, so as to determine whether or not the electronic device has used one of these virtual ports previously; if the determination is yes, then Other determine whether this virtual port is currently being used, wherein if this virtual port is not currently being used, then assign this not currently being used virtual port as the permanent port representing the actual port of the remote USB hub, and the number of this virtual port is transmitted to a system operation platform of the client device, as if the electronic device was connected to the client device via the virtual port; if the determination is no, then search for a virtual port that is not currently in use to be the permanent port representing the actual port of the remote USB hub, and the number of this virtual port is transmitted to a system operation platform of the client device, as if the electronic device was connected to the client device via the virtual port. Therein while searching for a virtual port that is not currently in use, the virtual port may be one that has not been used for the longest time, so as to reduce the duplication usage rate of virtual ports between the electronic device and the client device, thereby more efficiently assign virtual ports to various different electronic devices.

Via generating a virtual port to be the permanent port representing the actual port of the remote USB hub, the issue of a system operation platform repeatedly requesting driver program and user settings of the same electronic device may be prevented, so as to reduce memory wastage and user inconvenience when utilizing electronic devices through remote USB hub.

The aforementioned illustrations and following detailed descriptions are exemplary for the purpose of further explaining the scope of the present invention. Other objectives and advantages related to the present invention will be illustrated in the subsequent descriptions and appended drawings.

### BRIEF DESCRIPTION OF THE DRAWINGS

FIG. 1 shows a block diagram of a remote USB hub according to an embodiment of the present invention.

FIG. 2 shows a block diagram of a client device according to an embodiment of the present invention.

FIG. 3 shows the steps of a flowchart according to an embodiment of the present invention.

FIG. 4 shows the steps of a flowchart for a virtual port number assigning method according to an embodiment of the present invention.

FIG. 5 shows the steps of a flowchart for a virtual port number assigning method according to another embodiment of the present invention.

FIG. 6 shows a device schematic diagram according to an embodiment of the present invention.

### DETAILED DESCRIPTION OF THE PREFERRED EMBODIMENTS

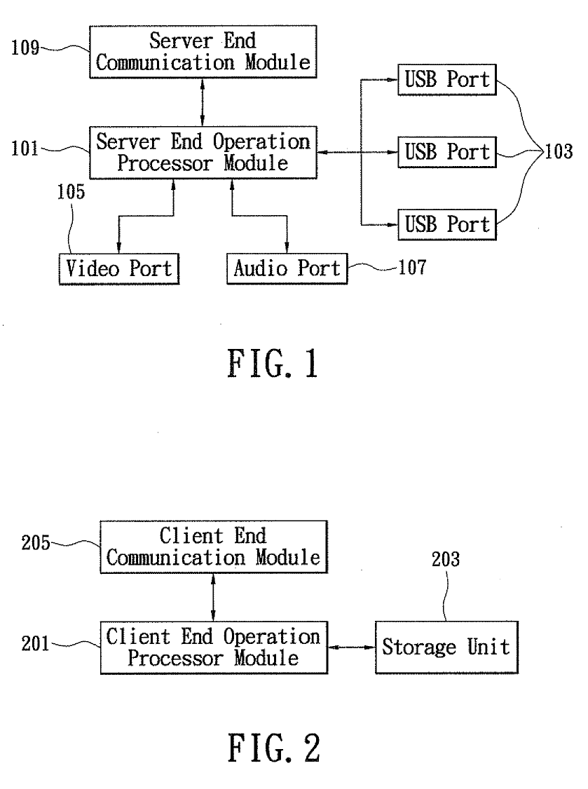

Refer to FIG. 1, which shows a block diagram of a remote USB hub according to an embodiment of the present invention, wherein the remote USB hub is used to connect an electronic device by wire or wirelessly and to transmit data to a local client device such as a notebook computer. As shown by FIG. 1, the remote USB hub includes a server end operation processor module 101, which acts as the processing center for data; an audio port 107, for connecting to a speaker device, alternatively a plurality of USB ports 103, for connecting to various electronic devices; and a server end communication module 109, coupled to the server end operation processor module 101 for transmitting data, the transmission using wire or being wireless transmission. The server end operation processor module 101 is firmer coupled to a video port 105, such as a DVI port, a VGA port, or a HDMI port, for connecting to a display device.

Refer to FIG. 2, which shows a block diagram of a client device according to an embodiment of the present invention, the client device is for transceiving data, and remotely utilize an electronic device connected to a remote USB hub. As shown by FIG. 2, the client device includes a client end operation processor module 201, which acts as the processing center for data; a client end communication module 205, coupled to the client end operation processor module 201, for transceiving data; and a storage unit 203, or a computer readable medium, coupled to the client end operation processor module 201, for storing the program and data of a virtual port number assigning method.

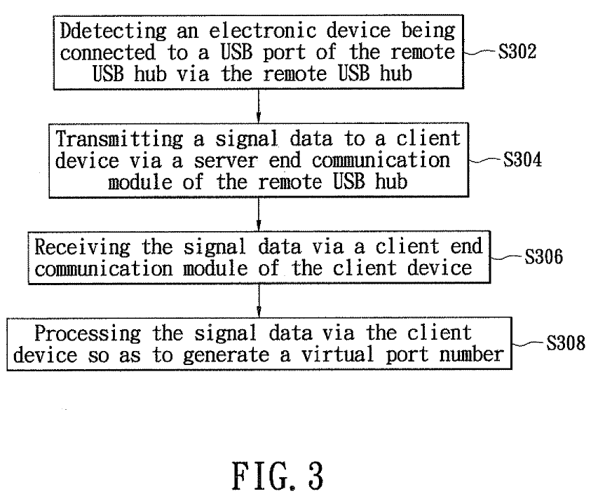

Refer to FIG. 3 in conjunction with FIGS. 1 and 2, which shows the steps of a flowchart according to an embodiment of the present invention, the steps including: detecting an electronic device being connected to a USB port 103 via the remote USB hub (S302); transmitting a signal data to a local client device via a server end communication module 109 of the remote USB hub (S304); receiving the signal data via a client end communication module 205 of the client device (S306); processing the signal data via the client device so as to generate a virtual port number (S308), and transmitting the virtual USB port number to the system operation platform of the local client device, so that this virtual USB port number may represent the USB port number for the electronic device at local client device.

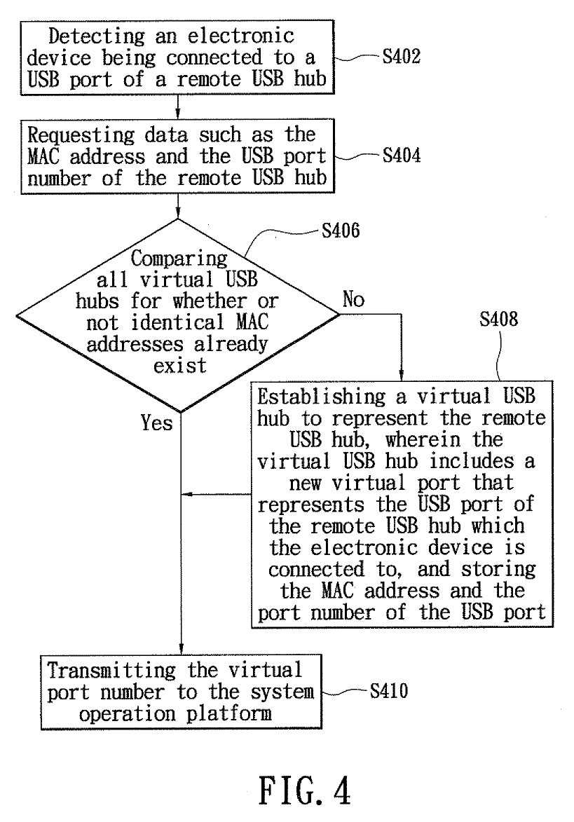

Refer to FIG. 4 in conjunction with FIGS. 1 and 2, which show the steps of a flowchart for a virtual port number assigning method according to an embodiment of the present invention, the steps include: detecting an electronic device being connected to a USB port 103 of a remote USB hub (S402); requesting data such as the MAC address and the port number of the USB port 103 of the remote USB hub (S404); comparing all virtual USB hubs for whether or not identical MAC addresses already exist (S406); if the comparison result is yes, then transmitting the virtual port number with the identical MAC address to the system operation platform of the client device (S410), so that this virtual port number may represent the USB port number at the system operation platform of the client device for the electronic device; if the comparison result is no, then generating a virtual USB hub to represent the remote USB hub, wherein the virtual USB hub includes a new virtual port that represents the USB port of the remote USB hub, and storing the MAC address and the port number of the USB port 103 (8408), then transmitting the newly generated virtual port number to the system operation platform of the client device (S410), so that this virtual port number may represent the USB port number at the system operation platform of the client device for the electronic device.

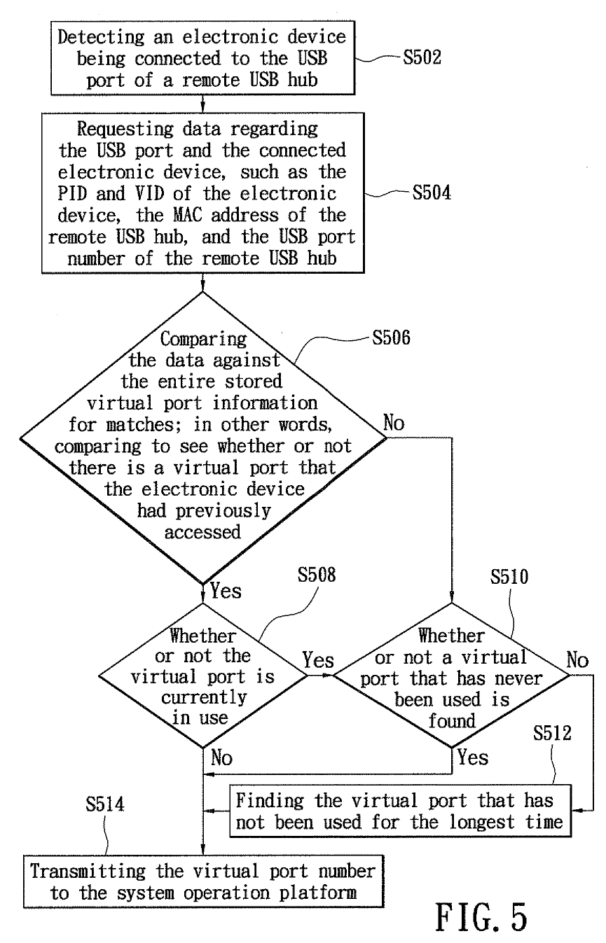

Refer to FIG. 5 in conjunction with FIGS. 1 and 2, which show the steps of a flowchart for a virtual port number assigning method according to another embodiment of the present invention, the steps include: detecting an electronic device being connected to the USB port 103 of a remote USB hub (S502); requesting data regarding the USB port and the connected electronic device, such as the PID and VID of the electronic device, the MAC address of the remote USB hub, and the port number of the USB port 103 (S504); comparing the data against the entire stored virtual port information for matches; in other words, comparing to see whether or not there is a virtual port that the electronic device had previously accessed (S506); if there is a virtual port that the electronic device had previously accessed, there further determine whether or not this virtual port is currently in use (8508); if this virtual port is not currently in use, then this virtual port is assigned as the permanent port representing USB port 103 of the remote USB hub, and this virtual port number is transmitted to a system operation platform of the client device (S514); on the other hand if this virtual port is currently in use, the determine whether or not there is a virtual port that have never been used (S510); if there is a virtual port that have never been used, then this virtual port is assigned as the permanent port representing the USB port 103 of the remote USB hub, and the port number of this virtual port is transmitted to a system operation platform of the client device (S514); if there is no virtual port that have never been used, then determine the virtual port that has not been used for the longest time (S512), and this virtual port is assigned as the permanent port representing the USB port 103 of the remote USB hub, and the port number of this virtual port is transmitted to a system operation platform of the client device (S514).

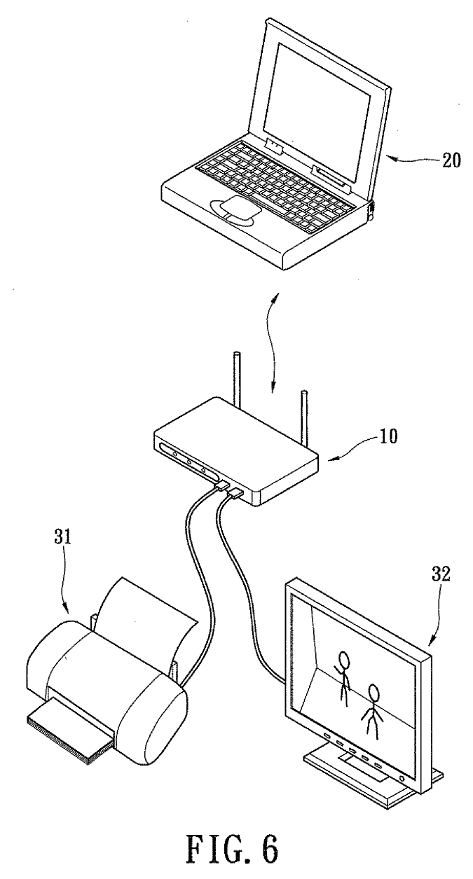

Refer to FIG. 6 in conjunction with FIGS. 1 and 2, which shows a device schematic diagram according to an embodiment of the present invention. FIG. 6 shows a remote USB hub 10, electronic device such as a printer 31 or a display device 32, and these electronic devices may connect to the remote USB hub 10 through USB port 103, then via wire or wireless transmission a local client device such as a notebook computer 20 may share and utilize the printer 31 and display device 32 that connects with the remote USB hub. Notebook computer 20 stored a virtual port number assigning program, which may simulate a plurality of virtual ports for the notebook computer 20, and permanently assign these virtual ports to the printer 31 or the display device 32 to represent the USB port number within the system operation platform (i.e. Windows or Linux) of the notebook computer 20, thereby prevent the issue of a system operation platform repeatedly requesting driver program and user settings due to nonpermanent port number, and thus user inconvenience is reduced. For example, if initially for the first time the printer 31 and the display device 32 is connected to the USB port 103 with port positions as indicated by FIG. 6, then for the second time the printer 31 and the display device 32 are connected to different USB port 103, the virtual port number assigning program of the notebook computer 20 may still assign the same virtual port to the printer 31 and the display device 32 as the first time, so as to prevent the system operation platform of the notebook computer 20 from repeatedly requesting driver program download and installation.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A virtual port number assigning method, applicable to a client device, for generating a virtual port at the client device to represent an actual port of a remote USB hub, the steps comprising:
detecting an electronic device being connected to the actual port of the remote USB hub;
requesting data regarding the actual port and the connected electronic device;
comparing the data, wherein the data is compared against previous generated virtual ports, so as to check whether a virtual port representing the actual port of the remote USB hub already exists; and
assigning the virtual port according to the comparison result.

2 The virtual port number assigning method according to claim 1, wherein the step of assigning of the virtual port according to the comparison result farther comprises:
if the comparison result is positive, assigning the virtual port as a permanent port of the client device representing the actual port of the remote USB hub, and transmitting port number of the assigned virtual port to a system operation platform of the client device.

3. The virtual port number assigning method according to claim 1, wherein the step of assigning the virtual port according to the comparison result further comprises:
if the comparison result is negative, generating a virtual USB hub at the client device to represent the remote USB hub, the virtual USB hub including a new virtual port, for representing the actual port of the remote USB hub; then the new virtual port is assigned as a permanent port of the client device representing the actual port of the remote USB hub, and port number of the assigned new virtual port is transmitted to a system operation platform of the client device.

4. The virtual port number assigning method according to claim 1, wherein the step of comparing the data further comprises comparing the data to all the previous generated virtual ports, so as to determine whether or not the electronic device has used one of these virtual ports previously, and assigning a virtual port according to the determined result.

5. The virtual port number assigning method according to claim 4, wherein the step of assigning the virtual port according to the determination result further comprises:
if the electronic device has previously used one of the virtual ports, determine whether the previously used virtual port is currently occupied or not.

6. The virtual port number assigning method according to claim 5, wherein if the previously used virtual port is not currently occupied, it is assigned as a permanent port of the client device representing the actual port of the remote USB hub, and port number of this virtual port is transmitted to a system operation platform of the client device.

7. The virtual port number assigning method according to claim 5, wherein if the previously used virtual port is currently occupied, then determine whether there is a virtual port that has never been used or not.

8. The virtual port number assigning method according to claim 7, wherein if there exist a virtual port that has never been used, this virtual port is assigned as a permanent port of the client device representing the actual port of the remote USB hub, and port number of this virtual port is transmitted to a system operation platform of the client device.

9. The virtual port number assigning method according to claim 7, wherein if there is no virtual port that has never been used, then the virtual port that has not been used for the longest time is determined, and this virtual port is assigned as the permanent port of the client device representing the actual port of the remote USB hub, and the number of this virtual port is transmitted to a system operation platform of the client device.

10. The virtual port number assigning method according to claim 1, wherein the actual port is a USB port.

11. The virtual port number assigning method according to claim 1, wherein the data comprises a MAC address of the remote USB hub, the port number of the actual port, a PID of the electronic device, and a VID of the electronic device.

12. A computer readable medium, for storing a virtual port number assigning program that is applicable to a client device for generating a virtual port at the client device to represent an actual port of a remote USB hub, the steps of the program comprising:
detecting an electronic device being connected to the actual port of the remote USB hub;
requesting data regarding the actual port and the connected electronic device;
comparing the data; and
assigning the virtual port according to the comparison result.
